(19) United States
(12) Patent Application Publication
(10) Pub. No.: US 2023/0042356 A1
(43) Pub. Date: Feb. 9, 2023

(54) WHITENING ADDITIVE

(71) Applicant: The Procter & Gamble Company, Cincinnati, OH (US)

(72) Inventors: Nathalie Sophie LETZELTER, West Lane Trimdon (GB); Adam COSTELLO, Tynemouth North Tyne Side (GB); Gregory Scot MIRACLE, Liberty Township, OH (US)

(21) Appl. No.: 17/858,103

(22) Filed: Jul. 6, 2022

(30) Foreign Application Priority Data
Jul. 6, 2021 (EP) 21184101.0

(51) Int. Cl. C11D 3/42; C11D 11/00; C11D 3/00; C11D 3/50; C11D 3/37; C11D 3/395

(52) U.S. Cl. CPC C11D 3/42; C11D 11/0017; C11D 3/0036; C11D 3/50; C11D 3/3715; C11D 3/3955

(57) ABSTRACT

A process of laundering fabrics, comprising the step of separately delivering a detergent and a whitening additive wherein the whitening additive comprises a soil release polymer, a hueing dye, and wherein if the whitening additive comprises a surfactant, the weight ratio of the polymer to the surfactant is at least 1:1, the whitening additive is substantially free of surfactant.

### TECHNICAL FIELD

The present invention is in the field of laundry. In particular, it relates to a process of laundering fabrics using a detergent and a whitening additive. It also relates to a whitening additive. The process and the additive are preferably used in industrial or institutional laundry (i.e., professional laundry). The laundering process produces outstanding results in terms of stain removal, whiteness maintenance and whiteness rejuvenation.

### BACKGROUND OF THE INVENTION

White fabrics seem to lose their whiteness with time due to use. Laundry additive compositions for providing benefits to white fabrics are known, see for example WO2020/229160 A1 and U.S. Pat. No. 8,449,626 B2.

There is a desire to reduce the amount of water used in a laundry process, especially in professional laundry without compromising on cleaning and whitening.

There is also a desire for concentrated products to reduce packaging and transport emissions.

There is still a need for laundering processes and laundry products which provide improved whitening even under heavy soil conditions and using low amounts of water. There is also a need for concentrated compositions to reduce packaging and transport emissions.

### SUMMARY OF THE INVENTION

According to the first aspect of the invention, there is provided a process of laundering fabrics, preferably in a professional laundry machine, the process comprises the steps of delivering a detergent and concurrently or subsequently a whitening additive.

The process comprises subjecting the fabric to at least two different products, a detergent and a whitening additive. The whitening additive comprises:

(a) a soil release polymer; and

(b) a hueing dye; and

(c) optionally a brightener.

Preferably, the whitening additive is substantially free of surfactant. If the whitening additive comprises a surfactant, the level of surfactant is low, the amount of surfactant is equal to or lower than the amount of polymer in the whitening additive. If the whitening additive comprises a surfactant, the weight ratio of polymer to surfactant is at least 1:1, at least 2:1, or at least 3:1.

The whitening additive is preferably substantially free of perfume. By “substantially free” is herein meant that the additive comprises less than 0.1%, more preferably less than 0.01% by weight of the additive of the corresponding ingredient.

The laundering process of the invention comprises one or more washing steps and one or more rinse steps. Preferably, the detergent and the washing additive are added separately, in the same or in a different washing or rinsing step.

Both, the detergent and the whitening additive can be delivered into a washing step. Preferably, the detergent is delivered into a washing step and the whitening additive is delivered into a rinse step. Preferably, the process of the invention comprises one or more washing steps and only one rinse. Processes using only one rinse rather than a plurality of rinses require less water and less energy consumption.

The process comprises the steps of delivering detergent and a whitening additive, preferably subsequently. By “subsequently” is herein meant that the whitening additive is delivered at least 1 minute, at least 5 minutes, at least 10 minutes or at least 15 minutes after the detergent. Preferably the whitening additive and the detergent are delivered in different steps, for example the detergent in a washing step and the whitening additive in a rinse step.

The process of the invention can also comprise the step of delivering bleach, after the detergent and before the whitening additive. Although any bleach can be used in the process of the invention, the use of halogen bleach, peroxyacid bleach and mixtures thereof is preferred herein. If halogen and peroxyacid bleach are both used in the same laundering process, they can be delivered separately from one another. Halogen bleach, e.g. hypochlorite bleach, sodium hypochlorite, is very effective for the removal of coloured stains and in addition provides sanitization of the washed items, that is particularly relevant in professional laundry.

The process provides good stain removal, good whiteness maintenance and whiteness rejuvenation even when the process comprises a single rinse step. The process is suitable for different types of fabrics, including loads of natural materials, synthetic materials and mixtures thereof. It has been found that cotton yellows substantially when washed repeated with sodium hypochlorite and also that synthetic materials, such as lycra and nylon are prone to yellowing, in particular when exposed to peroxyacid bleach, in particular to phtalimidoperoxy hexanoic acid (PAP). The process of the invention overcomes/reduce the yellowing issue, even when fabrics are exposed to bleach.

The process of the invention comprises the step of delivering a detergent, i.e., a laundry detergent comprising cleaning actives such as surfactants, builders, enzymes, etc. The detergent may comprise bleach or be free of bleach. It is also preferred that the bleach is provided not as part of the detergent but as part of a bleach additive. The whitening additive can be a separate product from the detergent and from the bleach additive.

The process of the invention allows for the delivery of different products, including, detergent, bleach, whitening additive, fabric enhancer, etc in different or the same steps of a laundry process. A preferred dosing regime involves the delivery of the detergent in a washing step, e.g. the first washing step and the whitening additive in the rinse. This dosing regime provides whitening benefits. Preferably the detergent is delivered before the whitening additive. Preferably the detergent is delivered at least 1 minute, at least 5 minutes or at least 10 minutes before the whitening additive. The whitening additive may comprise a brightener. This further contributes to whiteness enhancement including whitening rejuvenation.

A preferred dosing regime involves the delivery of the detergent first, then the bleach and finally the whitening additive in a rinse step. This regime is also advantageous in the case of detergents comprising enzymes because the enzymes act before the bleach thereby avoiding the negative interaction between bleach and enzymes. The benefit is greater in the case of hypochlorite bleach. This regime has been found beneficial from a stain removal standpoint.

Another preferred dosing regime involves the delivery of bleach first then the detergent and subsequently the whitening additive, e.g. in the last rinse. The last rinse may be the only rinse.

Still another preferred dosing regime involves the delivery of detergent in a washing step, bleach at the beginning of the rinse; the whitening additive is delivered in the rinse at least 1 minute, at least 5 minutes or at least 10 minutes after the bleach. This regime can provide environmental benefits. It allows for a reduced number of cleaning steps, thereby saving time and energy.

According to another aspect of the invention, there is provided a concentrated whitening additive composition. The concentrated composition presents an improved environmental profile over traditional whitening additive compositions (reduced volume and packaging that translate into reduced transport emissions). Without being bound by theory, it is believed that the soil release polymer prevents patchy damage from the dye that could occur when there is insufficient dilution or poor additive dispersion in a packed machine and there is no further rinse. The risk of patchy damage is higher on full loads, ie. when the laundry machine is packed to capacity as is common in a professional context. The whitening additive composition provides excellent white care even when the laundry process involves the use of only one rinse. The whitening additive counteracts the yellowing of fabrics and allows for whiteness rejuvenation. More whitening benefits are obtained when the whitening additive further comprises a brightener. The preferred brightener for use herein is Tinopal CBS. The additive provides most benefit when used with light or white loads. However, due to the controlled deposition of the hueing dye, it is also suitable to be used on dark colours whenever a multicycle cleaning benefit is desirable.

Additionally, with only rinse, more soil carry-over is present at the end of the wash process. The whitening additive also prevents soil re-deposition and ensures good whiteness maintenance over multiple cycles (as good or better as with more rinses).

Preferably, the concentration of soil release polymer in the rinse liquor is from 10 ppm to 300 ppm, from 20 ppm to 200 ppm or from 30 ppm to 50 ppm. The concentration of the hueing dye in the rinse liquor is from about 10 ppb to about 100 ppb or from about 20 ppb to about 50 ppb.

The process of the invention may also include the step of delivery a fabric enhancer in a third or subsequent step. Preferably the fabric enhancer comprises a perfume wherein at least part of the perfume may be provided as part of a slow perfume delivery system, e.g. perfume microcapsules, pro-perfumes, or mixtures thereof.

According to another aspect of the invention, there is provided a whitening additive composition comprising:
(a) at least 10 or at least 15% by weight of the composition of soil release polymer; and
(b) at least 0.01%, from about 0.01 to about 0.1%, or from about 0.001 to about 0.05% by weight of the composition of hueing dye; and
(c) optionally a brightener.
   and wherein the whitening additive is preferably substantially free of surfactant and optionally but preferably, free of perfume.

If the whitening additive comprises a surfactant, the level of surfactant is low, the amount of surfactant is equal to or lower than the amount of polymer in the whitening additive. If the whitening additive comprises a surfactant, the polymer and the surfactant are in a weight ratio of at least 1:1, at least 2:1, or at least 3:1.

According to another aspect of the invention, there is provided the use of the whitening additive of the invention to provide whiteness maintenance and rejuvenation, especially on cotton, polyester and polycotton fabrics, and to provide multicycle cleaning benefits, especially on polyester and polycotton fabrics. There is also provided the use of the whitening additive of the invention to provide grease cleaning benefits on cotton fabrics.

The elements of the process of the invention described in relation to the first aspect of the invention apply mutatis mutandis to the other aspects of the invention.

### DETAILED DESCRIPTION OF THE INVENTION

The present invention envisages a process of laundering fabrics, preferably in a professional laundry machine. The process involves contacting the fabrics with detergent and concurrently or subsequently with a whitening additive. The process provides improved cleaning and better white care, including whitening rejuvenation even when used in a laundering process having a single rinse. The invention also envisages a concentrated whitening additive composition comprising a soil release polymer and a hueing dye and preferably a brightener. The whitening additive is preferably substantially free of surfactant and preferably substantially free of perfume. The invention also envisages the use of the whitening additive to improve the whitening appearance of all fabric types and to provide multicycle whiteness benefits (soil anti-redeposition and yellowing rejuvenation). Lastly, the additive also provides grease cleaning benefits even after a single cycle. It also allows for a reduced number of rinses, thereby saving time, water, and energy.

Professional laundry includes institutional and industrial (sometimes also referred to as commercial) laundry. Institutional laundry refers to textile washing operations usually run in business sites, normally referred to as On-Premise or In-House Laundry Operations. Typical businesses can be for instance hotels, restaurants, care homes, hospitals, spas, health or sport clubs, schools, and similar institutions. Industrial laundry refers to textile washing operations carried out in dedicated places typically for the above businesses.

By “professional laundry machine” is herein meant a laundry machine with a capacity which is usually higher than 5 kg, higher than 10 kg or higher than 20 kg of dry laundry.

There are two main types of professional laundry machines: front load which operate in a batch mode or tunnel washing machines that operate in continuous mode. The professional laundry machines for use herein, in the case of front load have a drum volume of at least about 0.05 m³, at least 0.1 m³, at least 0.3 m³ or at least 0.5 m³. The professional laundry machines for use herein, in the case of front load have a drum diameter of at least about 0.4 m, at least 0.8 m or at least 1 m. In the case of tunnel washing machines, typically found in industrial or commercial laundries, the tunnel has a diameter of at least about 1.5 m, at least 3 m or at least 5 m.

The essential actives of the invention are detergent and a whitening additive, optionally bleach can be delivered, preferably in the form of an additive. Optionally, the process involves the delivery of a detergent and a fabric enhancer.

### Delivery Regimes

The process of the present invention requires the delivery of detergent and subsequently a whitening additive. Preferably, the detergent is first delivered and the whitening additive is delivered subsequently. The process also envisages embodiments in which detergent and optionally a fabric enhancer is/are delivered. The process is flexible regarding when the different products are delivered into the laundry process. Some delivery regimes include the delivery of detergent in the first washing step, bleach in the second washing step or in the rinse and subsequently delivering the whitening additive. Usually a professional laundry process includes three different rinse steps, the whitening additive can be delivered into the first, second or third rinse steps. Preferably the process of the invention includes only one rinse step. As indicated before, these kind of dosing regimes in which the detergent is dosed in the first washing step provide improved stain removal.

Another preferred dosing regime involves the delivery of detergent in the first washing step and the delivery of whitening additive and optionally bleach, in the second washing step. Preferably, the whitening additive is delivered at least 5 minutes, at least 10 minutes or at least 15 minutes after the bleach. This again provides a good stain removal. Optionally a fabric enhancer is delivered in the last washing step.

Other dosing regimes provide for the delivery of detergent in the first and whitening additive in the second washing step. These dosing regimes provide improved whiteness maintenance. The whitening additive could for example be delivered in the second washing step together with the detergent or after the detergent. Alternatively, the whitening additive could be delivered in the rinse. Another alternative could be the delivery of the detergent and bleach in the second washing step and the whitening additive in a rinse, preferably in a single rinse process.

### Whitening Additive

The whitening additive has a pH of 4.8 (as measured at 1% wt solution in distilled water at 20° C.).

Preferably the whitening additive is in liquid form so it can be easily delivered by means of a displacement pump, for example a peristaltic pump. The additive can be an aqueous unstructured liquid. The additive comprises a soil release polymer in a level of at least 10%, from about 10% to about 80%, from about 15% to about 60% or from about 20% to about 50% by weight of the whitening additive. The hueing dye is present in the whitening additive at a level of at least 0.001%, 0.0025%, 0.005%, or 0.01%, from about 0.01% to about 0.1%, from about 0.01% to about 0.08% or from about 0.01% to about 0.04% by weight of the whitening additive. If a brightener is present in the whitening additive the level is from about 0.03% to about 5%, or from about 0.1% to about 2% by weight of the whitening additive.

The additive is substantially free of surfactant and preferably free of perfume and ingredients acting on soil in the washing cycle, such as bleaches, builders, protease and amylase enzymes.

It has been surprisingly found that the polymer prevents patchy damage from the dye that can occur under certain circumstances, for example when the laundry machine is very full.

### Soil Release Polymer

Preferred soil release polymers for use herein include polyester soil release polymers having a structure according to the formula below:

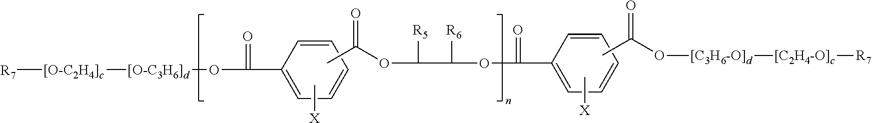

wherein:
each R₅ and R₆ is independently selected from H or CH₃ for each of the n repeating units; c and d are, based on molar average, a number independently selected from 0 to 200, wherein the sum of c+d is from 2 to 400, and the individual c and d repeating units may be arranged in any order;

R₇ is selected from H, and more preferably, from C₁₋₄ alkyl, —CH₂—CH₂—SO₃⁻(Mⁱ⁺)_{1/i}, or

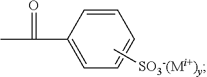

more preferably methyl; and
n is, based on molar average, from 1 to 50, from 1 to 25, or from 1 to 10;
each X is independently selected from H or SO₃⁻(Mⁱ⁺)_{y};
wherein, M is H or a mono- or divalent cation;
i is 1 or 2y is 1/i.

More preferably, M is H or an alkali metal cation and/or earth alkali metal ion.

Even more preferably, the soil release polymer comprises a nonionic terephthalate-derived soil release polymer having a structure according to the formula below:

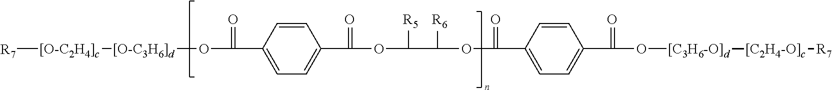

wherein:
each R₅ and R₆ is independently selected from H or CH₃ for each of the n repeating units, more preferably, one of the R₅ and R₆ is H, and another is CH₃;
c and d are, based on molar average, a number independently selected from 0 to 200, and wherein the sum of c+d is from 2 to 400, more preferably, d is from 0 to 50 and c is from 1 to 200, more preferably, d is 0 to 10 and c is 5 to 150;
R₇ is C₁-4 alkyl and more preferably methyl; and
n is, based on molar average, from 1 to 50, from 1 to 25, or from 1 to 10.

Typically, the wash liquor comprises from 10 ppm to 200 ppm, or from 20 ppm to 150 ppm, or from 40 ppm to 180 ppm soil release polymer.

### Hueing Dye

As used herein, the term hueing dye refers to a dye that when on white cotton provides a hue to the cloth with a relative hue angle of 210 to 345, or even a relative hue angle of 240 to 345, or even a relative hue angle of 250 to 325, 260 to 325, or 270 to 310.

The hueing dye (sometimes referred to as bluing or shading dyes) typically provides a blue or violet shade to fabric. Hueing dyes can be used either alone or in combination to create a specific shade of hueing and/or to shade different fabric types. This may be provided for example by mixing a red and green-blue dye to yield a blue or violet shade. The hueing dye may be selected from any chemical class of dye as known in the art, including but not limited to acridine, anthraquinone (including polycyclic quinones), azine (including oxazine and thiazine), azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, phthalocyanine, pyrazoles, stilbene, styryl, triarylmethane (including triphenylmethane and xanthenes), and mixtures thereof.

Preferred hueing dyes are selected from small molecule dyes and polymeric dyes.

### Small Molecule Dyes

Suitable small molecule dyes may be selected from the group consisting of dyes falling into the Colour Index (C.I., Society of Dyers and Colourists, Bradford, UK) classifications of Acid, Direct, Basic, Reactive, Solvent or Disperse dyes. Preferably such dyes can be classified as Blue, Violet, Red, Green or Black, and provide the desired shade either alone or in combination with other dyes or in combination with other adjunct ingredients. Reactive dyes may contain small amounts of hydrolyzed dye as sourced, and in detergent formulations or in the wash may undergo additional hydrolysis. Such hydrolyzed dyes and mixtures may also serve as suitable small molecule dyes.

Preferably, small molecule dyes can be selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

### Polymeric Dyes

Suitable polymeric dyes include dyes selected from the group consisting of polymers containing covalently bound (sometimes referred to as conjugated) chromogens, (also known as dye-polymer conjugates), for example polymers with chromogen monomers co-polymerized into the backbone of the polymer and mixtures thereof.

Polymeric dyes include: (a) Reactive dyes bound to water soluble polyester polymers via at least one and preferably two free OH groups on the water soluble polyester polymer. The water soluble polyester polymers can be comprised of comonomers of a phenyl dicarboxylate, an oxyalkyleneoxy and a polyoxyalkyleneoxy; (b) Reactive dyes bound to polyamines which are polyalkylamines that are generally linear or branched. The amines in the polymer may be primary, secondary and/or tertiary. Polyethyleneimine in one aspect is preferred. In another aspect, the polyamines are ethoxylated; (c) Dye polymers having dye moieties carrying negatively charged groups obtainable by copolymerization of an alkene bound to a dye containing an anionic group and one or more further alkene comonomers not bound to a dye moiety; (d) Dye polymers having dye moieties carrying positively charged groups obtainable by copolymerization of an alkene bound to a dye containing an cationic group and one or more further alkene comonomers not bound to a dye moiety; (e) Polymeric azo polyoxyalkylene dyes containing carboxylate groups; in some aspects those having carboxylic acid groups with a pKa value below 4, or below 3, or even below 2, may be preferred; and (f) dye polymer conjugates comprising at least one reactive dye and a polymer comprising a moiety selected from the group consisting of a hydroxyl moiety, a primary amine moiety, a secondary amine moiety, a thiol moiety and combinations thereof said polymers preferably selected from the group consisting of polysaccharides, proteins, polyalkyleneimines, polyamides, polyols, and silicones. In one aspect, carboxymethyl cellulose (CMC) may be covalently bound to one or more reactive blue, reactive violet or reactive red dye such as CMC conjugated with C.I. Reactive Blue 19, sold by Megazyme, Wicklow, Ireland under the product name AZO-CM-CELLULOSE, product code S-ACMC.

Other suitable polymeric dyes include polymeric dyes selected from the group consisting of alkoxylated triphenyl-methane polymeric colorants, alkoxylated carbocyclic and alkoxylated heterocyclic azo colorants, including alkoxylated thiophene polymeric colorants, and mixtures thereof. Preferred polymeric dyes comprise the optionally substituted alkoxylated dyes, such as alkoxylated triphenyl-methane polymeric colorants, alkoxylated carbocyclic and alkoxylated heterocyclic azo colorants including alkoxylated thiophene polymeric colorants, and mixtures thereof, such as the fabric-substantive colorants sold under the name of Liquitint® (Milliken, Spartanburg, S.C., USA).

Suitable polymeric bluing dyes are illustrated below. As with all such alkoxylated compounds, the organic synthesis may produce a mixture of molecules having different degrees of alkoxylation. During a typical ethoxylation process, for example, the randomness of the ethylene oxide addition results in a mixture of oligomers with different degrees of ethoxylation. As a consequence of its ethylene oxide number distribution, which often follows a Poisson law, a commercial material contains substances with somewhat different properties. For example, in one aspect the product resulting from an ethoxylation is not a single compound containing five (CH₂CH₂O) units as the general structure (Formula A below, with x+y=5) may suggest. Instead, the product is a mixture of several homologs whose total of ethylene oxide units varies from about 2 to about 10. Industrially relevant processes will typically result in such mixtures, which may normally be used directly to provide the fabric shading dye, or less commonly may undergo a purification step.

Preferably, the hueing dye has the following structure:

Dye-(G)ₐ-NR¹R²,

wherein the -(G)ₐ-NR¹R² group is attached to an aromatic ring of the dye, G is independently —SO₂— or —C(O)—, which may be derived from an —SO₃H or —CO₂H residue of the Dye, the index a is an integer with a value of 0 or land R¹ and R² are independently selected from H, a polyoxyalkylene chain, C₁₋₈ cycloalkyl, C₁₋₈ alkyl, C₇₋₁₆ alkaryl, the cycloalkyl, alkyl and alkaryl groups may comprise ether (C—O—C), ester (includes —C(O)O— and —OC(O)O—) and/or amide (includes —C(O)NH— and —C(O)NR³— wherein R³ is C₁-4 alkyl) links, one or two pair of hydrogen atoms on adjacent carbons may be removed to form carbon-carbon double or triple bonds, the alkyl chains may be substituted with —Cl, —Br, —CN, —OH, a polyoxyalkylene chain, and mixtures thereof; C₆₋₁₀ aryl, optionally substituted with a polyoxyalkylene chain, and mixtures thereof, said polyoxyalkylene chains independently having from about 2 to about 100, about 2 to about 50, about 3 to about 30 or about 4 to about 20 repeating units. Preferably, the repeating units are selected from the group consisting of ethylene oxide, propylene oxide, butylene oxide and mixtures thereof. Preferably, the repeating units are essentially ethylene oxide.

Preferably, the hueing dye may have the structure of Formula A:

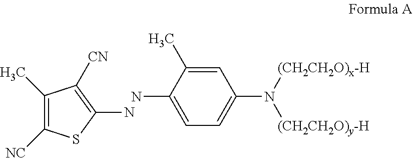

wherein the index values x and y are independently selected from 1 to 10.

The shading dye may have the following structure:

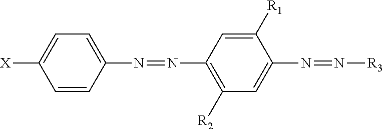

wherein:

R₁ and R₂ are independently selected from the group consisting of: H; alkyl; alkoxy;

alkyleneoxy; alkyl capped alkyleneoxy; urea; and amido;

R₃ is a substituted aryl group;

X is a substituted group comprising a sulfonamide moiety and optionally an alkyl and/or

aryl moiety, and wherein the substituent group comprises at least one alkyleneoxy chain. Non-limiting examples of such suitable shading dyes are shown below as Formulas B through E.

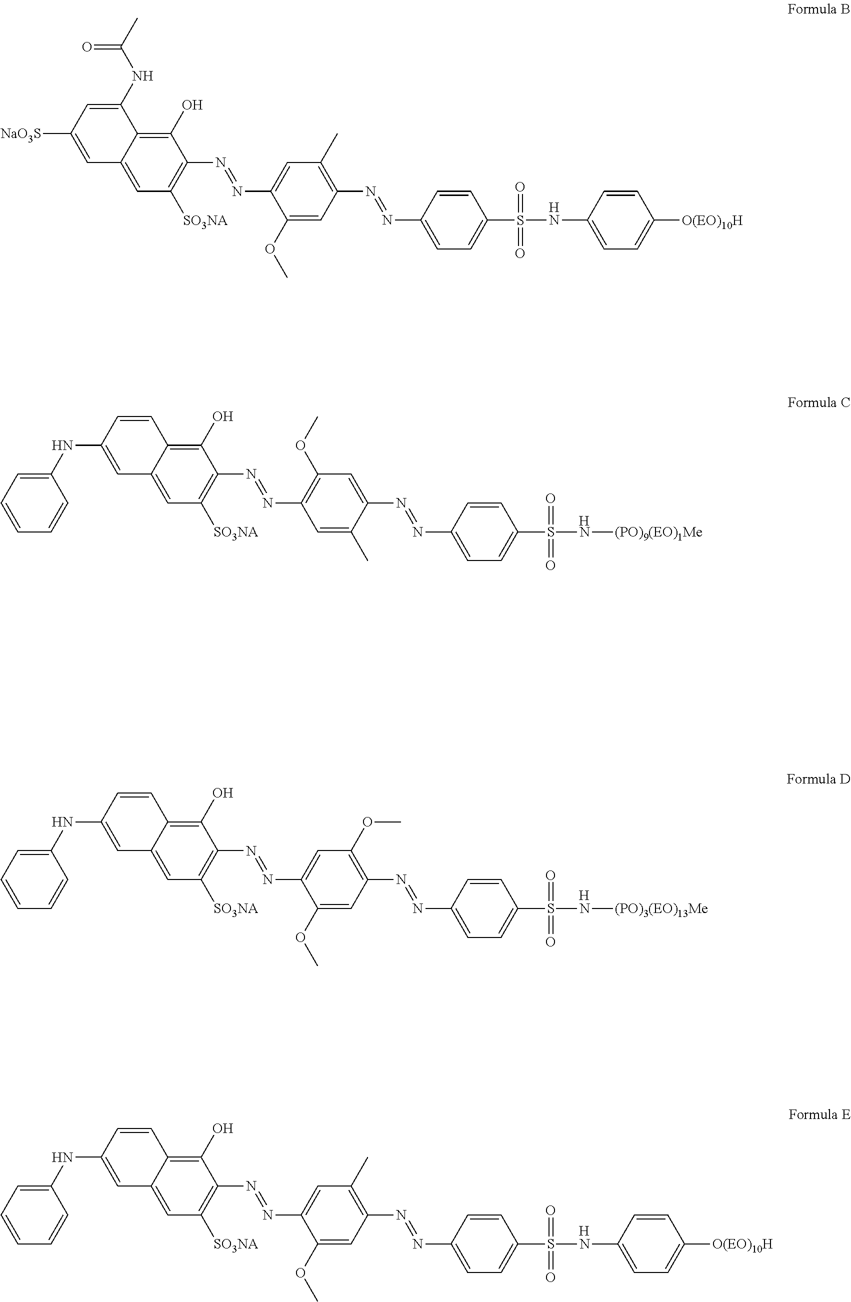

Preferably, the composition comprises at least 0.01% by weight of the composition of hueing dye, preferably from 0.01 to 0.04% by weight of the composition of hueing dye.

### Brightener

Any optical brighteners or other brightening agents known in the art are suitable for use herein. Commercial optical brighteners which may be useful in the present invention can be classified into subgroups, which include derivatives of stilbene, pyrazoline, coumarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982). Specific examples of optical brighteners which are useful in the present compositions are those identified in U.S. Pat. No. 4,790,856, issued to Wixon on Dec. 13, 1988. These brighteners include the PHORWHITE series of brighteners from Verona. Other brighteners disclosed in this reference include: Tinopal UNPA, Tinopal CBS and Tinopal SBM; available from Ciba-Geigy; Artic White CC and Artic White CWD, available from Hilton-Davis, located in Italy; the 2-(4-stryl-phenyl)-2H-napthol[1,2-d]triazoles; 4,4′-bis-(1,2,3-triazol-2-yl)-stil-benes; 4,4′-bis(stryl)bisphenyls; and the aminocoumarins. Specific examples of these brighteners include 4-methyl-7-diethyl-amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d] oxazole; and 2-(stilbene-4-yl)-2H-naphtho-[1,2-d]triazole. See also U.S. Pat. No. 3,646,015, issued Feb. 29, 1972 to Hamilton. Anionic brighteners are preferred herein. Preferred brightener is Tinopal CBS (Disodium 4,4′-bis(2-sulfostyryl))biphenyl.

Preferably, the brightener is present in the rinse liquor in a level of from about 0.1 to about 100 ppm, from about 1 to about 30 ppm or from about 2 to about 10 ppm. Preferably the level of brightener in the whitening additive is from 0.03% to 5%, or from 0.1% to 2% by weight of the whitening additive.

### Detergent Composition

The detergent composition for use herein preferably has a near-neutral pH, i.e. from about 5 to about 9, from about 6 to about 8 (as measured at 1% wt solution in distilled water at 20° C.). Compositions having this pH range have been found to be less aggressive on fabrics than acidic or alkaline solutions. Preferably, the detergent is a liquid detergent.

### Detersive Surfactant

Compositions suitable for use herein comprises from 5% to 70% by weight, from 10% to 60% by weight, from 20% to 50% by weight, of a certain kind of detersive surfactant component. Such an essential detersive surfactant component must comprise anionic surfactants, nonionic surfactants, or combinations of these two surfactant types.

Suitable anionic surfactants useful herein can comprise any of the conventional anionic surfactant types typically used in liquid detergent products. These include the alkyl benzene sulfonic acids and their salts as well as alkoxylated or un-alkoxylated alkyl sulfate materials.

Preferred anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is especially preferred. Preferably the anionic surfactant comprises at least 50%, at least 60% and especially 70% by weight of the anionic surfactant of LAS.

Another preferred type of anionic surfactant comprises ethoxylated alkyl sulfate surfactants. Such materials, also known as alkyl ether sulfates or alkyl polyethoxylate sulfates, are those which correspond to the formula:

R′—O—(C₂H₄O)ₙ—SO₃M

wherein R′ is a C₈-C₂₀ alkyl group, n is from about 1 to 20, and M is a salt-forming cation. Preferably, R′ is C₁₀-C₁₈ alkyl, n is from about 1 to 15, and M is sodium, potassium, ammonium, alkylammonium, or alkanolammonium. R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the compositions of this invention and used as or in any anionic surfactant component which may be present.

Preferred unalkoyxylated, e.g., unethoxylated, alkyl ether sulfate surfactants are those produced by the sulfation of higher C₈-C₂₀ fatty alcohols. Conventional primary alkyl sulfate surfactants have the general formula:

ROSO₃⁻M⁺

wherein R is typically a linear C₈-C₂₀ hydrocarbyl group, which may be straight chain or branched chain, and M is a water-solubilizing cation. Preferably R is a C₁₀-C₁₅ alkyl, and M is alkali metal. Most preferably R is C₁₂-C₁₄ and M is sodium.

Suitable nonionic surfactants useful herein can comprise any of the conventional nonionic surfactant types typically used in liquid detergent products. These include alkoxylated fatty alcohols, ethylene oxide (EO)-propylene oxide (PO) block polymers, and amine oxide surfactants. Preferred for use in the liquid detergent products herein are those nonionic surfactants which are normally liquid.

Preferred nonionic surfactants for use herein include the alcohol alkoxylate nonionic surfactants. Alcohol alkoxylates are materials which correspond to the general formula:

R₁(CₘH₂ₘO)ₙOH

wherein R¹ is a C₈-C₁₆ alkyl group, m is from 2 to 4, and n ranges from about 2 to 12.

Preferably R¹ is an alkyl group, which may be primary or secondary, that contains from about 9 to 15 carbon atoms, more preferably from about 10 to 14 carbon atoms. Preferably also the alkoxylated fatty alcohols will be ethoxylated materials that contain from about 2 to 12 ethylene oxide moieties per molecule, or from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15 or from about 8 to 15. Alkoxylated fatty alcohol nonionic surfactants have been marketed under the tradenames Neodol and Dobanol by the Shell Chemical Company.

Another type of nonionic surfactant which is liquid and which may be utilized in the compositions of this invention comprises the ethylene oxide (EO)-propylene oxide (PO) block polymers. Materials of this type are well known nonionic surfactants which have been marketed under the tradename Pluronic. These materials are formed by adding blocks of ethylene oxide moieties to the ends of polypropylene glycol chains to adjust the surface active properties of the resulting block polymers. EO-PO block polymer nonionics of this type are described in greater detail in Davidsohn and Milwidsky; Synthetic Detergents, 7th Ed.; Longman Scientific and Technical (1987) at pp. 34-36 and pp. 189-191 and in U.S. Pat. Nos. 2,674,619 and 2,677,700.

Yet another suitable type of nonionic surfactant useful herein comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R₂.qH₂O. In this formula, R is a relatively long-chain hydrocarbyl moiety which can be saturated or unsaturated, linear or branched, and can contain from 8 to 20, from 10 to 16 carbon atoms, and is more preferably C₁₂-C₁₆ primary alkyl. R′ is a short-chain moiety preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

In the liquid detergent compositions herein, the essential detersive surfactant component may comprise combinations of anionic and nonionic surfactant materials. When this is the case, the weight ratio of anionic to nonionic will typically range from 100:1 to 1:100, more typically from 20:1 to 1:20.

### Laundry Washing Adjuncts

The detergent compositions herein, preferably in liquid form, comprise from 0.1% to 30% by weight, from 0.5% to 20% by weight or from 1% to 10% by weight, of one or more of certain kinds of laundry washing adjuncts. Such laundry washing adjuncts can be selected from detersive enzymes, builders, chelants, soil release polymers, soil suspending polymers, dye transfer inhibition agents, bleach, suds suppressors, fabric care benefit agents, solvents, stabilizers, buffers, structurants, antioxidants and perfumes and combinations of these adjunct types. All of these materials are of the type conventionally utilized in laundry detergent products.

### Detersive Enzymes

Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, mannanases, pentosanases, malanases, β-glucanases, arabinosidases, hyaluronidase, chondroitinase, laccase, and known amylases, or combinations thereof. A preferred enzyme combination comprises a cocktail of conventional detersive enzymes like protease, lipase, cutinase and/or cellulase in conjunction with amylase. Detersive enzymes are described in greater detail in U.S. Pat. No. 6,579,839.

If employed, enzymes will normally be incorporated into the base detergent compositions herein at levels sufficient to provide up to 10 mg by weight, more typically from about 0.01 mg to about 5 mg, of active enzyme per gram of the composition. Stated otherwise, the aqueous liquid detergent compositions herein can typically comprise from 0.001% to 5% or from 0.01% to 1% by weight, of a commercial enzyme preparation. Protease enzymes, for example, are usually present in such commercial preparations at levels sufficient to provide from 0.005 to 0.1 Anson units (AU) of activity per gram of detergent composition.

The detergent may also include from about 0.05 to about 0.5% of preservatives non-limiting examples of which include didecyl dimethyl ammonium chloride which is available under the tradeneme UNIQUAT (from Lonza of Basel Switzerland), 1,2-benzisothiozolin-3-one, which is available under the tradename PROPEL (from Arch Chemicals of Norwalk, Conn.), dimethylol-5,5-dimethylhydantoin which is available under the tradeneme DANTOGUARD (from Lonza of Basel Switzerland), 5-Chloro-2-methyl-4-isothiazolin-3-one/2-methyl-4-isothiazolin-3-one, which is available under the tradename KATHON (from Rohm and Haas of Philadelphia, Pa.), and mixtures thereof

### Other Fabric Care Benefit Agents

The detergent composition for use herein may also comprise additional fabric care or benefit agents which can be deposited onto fabrics being laundered and which thereupon provide one or more types of fabric care or treatment benefits. Such benefits can include, for example, fabric softness, anti-static effects, ease-of-ironing benefits, anti-abrasion benefits, anti-pilling effects, color protection, wrinkle removal or improved resistance to wrinkling, fabric substantive perfume or odor benefits, malodor protection benefits, and the like.

A wide variety of materials which are suitable for providing such benefits and which can be deposited onto fabrics being laundered are known in the art. Such materials can include, for example, clays; starches; polyamines; un-functionalized and functionalized silicones such as aminosilicones and quaternary nitrogen-containing cationic silicones; cellulosic polymers, and the like. Materials of these types are described in greater detail in one or more of the following publications: U.S. Pat. Nos. 6,525,013; 4,178,254; WO 02/40627; WO 02/18528; WO 00/71897; WO 00/71806; WO 98/39401; and WO 98/29528.

If employed, such additional fabric care benefit agents polymers can typically be incorporated into the liquid laundry detergent compositions herein in concentrations ranging from 0.05% to 20%, by weight, depending upon the nature of the materials to be deposited and the benefit(s) they are to provide. More preferably, such fabric care benefit agents can comprise from 0.1% to 10%, by weight of the composition.

### Fabric Enhancer

The fabric enhancer for use herein comprises a fabric softening active. Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof. Preferably the fabric softening active is a quaternary ammonium compound.

Typical minimum levels of incorporation of the fabric softening active in the present fabric enhancer is at least about 1%, alternatively at least about 2%, alternatively at least about at least about 3%, alternatively at least about at least about 5%, alternatively at least about 10%, and alternatively at least about 12%, by weight of the fabric enhancer. The fabric enhancer may typically comprise maximum levels of fabric softening active of about less than about 90%, alternatively less than about 40%, alternatively less than about 30%, alternatively less than about 20%, by weight of the fabric enhancer.

Fabric enhancers suitable for use herein comprise perfume microcapsules, preferably the fabric enhancer also comprises additional perfume to that found in the microcapsules. The microcapsules comprise a core material and a wall material that at least partially surrounds, but preferably completely surrounds, the core material.

Useful wall materials include materials selected from the group consisting of polyethylenes, polyamides, polystyrenes, polyisoprenes, polycarbonates, polyesters, polyacrylates, polyureas, polyurethanes, polyolefins, polysaccharides, epoxy resins, vinyl polymers, and mixtures thereof. In one aspect, useful wall materials include materials that are sufficiently impervious to the core material and the materials in the environment in which the benefit agent containing delivery particle will be employed, to permit the delivery benefit to be obtained. Suitable impervious wall materials include materials selected from the group consisting of reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates and mixtures thereof. In one aspect, the wall material comprises melamine cross-linked with formaldehyde.

The core material comprises a perfume. In one aspect, said perfume comprises perfume raw materials selected from the group consisting of alcohols, ketones, aldehydes, esters, ethers, nitriles alkenes and mixtures thereof. In one aspect, said perfume may comprise a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3 and mixtures thereof. Perfume raw materials having a boiling point B.P. lower than about 250° C. and a ClogP lower than about 3 are known as Quadrant I perfume raw materials, perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. In one aspect, said perfume comprises a perfume raw material having B.P. of lower than about 250° C. In one aspect, said perfume comprises a perfume raw material selected from the group consisting of Quadrant I, II, III perfume raw materials and mixtures thereof. In one aspect, said perfume comprises a Quadrant III perfume raw material. Suitable Quadrant I, II, III and IV perfume raw materials are disclosed in U.S. Pat. No. 6,869,923 B1.

In one aspect, said perfume comprises a Quadrant IV perfume raw material. While not being bound by theory, it is believed that such Quadrant IV perfume raw materials can improve perfume odor “balance”. Said perfume may comprise, based on total perfume weight, less than about 30%, less than about 20%, or even less than about 15% of said Quadrant IV perfume raw material.

The perfume raw materials and accords may be obtained from one or more of the following companies Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.), Millennium Specialty Chemicals (Olympia Fields, Ill.), Polarone International (Jersey City, N.J.), Fragrance Resources (Keyport, N.J.), and Aroma & Flavor Specialties (Danbury, Conn.).

The fabric enhancer preferably comprises from about 0.01 to about 10, from about 0.1 to about 8, or even from about 0.2 to about 5 weight % of said particle based on total composition weight.

### Bleach

The bleach if delivered in the process of the invention can be delivered as part of a detergent and/or as part of an additive. Preferably, it is delivered in the form of an additive. The additive may be formulated either as solid or liquid, preferably the bleach additive is in liquid form and contains halogen bleach. In the cases in which the bleaching compositions are formulated as liquids, including gel and paste form, the bleaching compositions are preferably but not necessarily formulated as aqueous compositions. Liquid bleaching compositions can be preferred herein for convenience of use. Preferred liquid bleaching compositions of the present invention are aqueous and therefore, comprise water in an amount of from 60% to 98%, of from 70% to 97% or from 80% to 97% by weight of the total composition.

Any bleach known to those skilled in the art may be suitable for use herein. Preferred bleaches include halogen bleaches such as for instance chlorine, bromine, chlorine dioxide, chlorite salts, etc. Preferred halogen bleaches are hypohalite salts. Suitable hypohalite bleaches may be provided by a variety of sources, including bleaches that lead to the formation of positive halide ions and/or hypohalite ions, as well as bleaches that are organic based sources of halides such as chloroisocyanurates. Suitable hypohalite bleaches for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chloroamines and chlorohydantoins. For the bleaching compositions herein, the preferred hypohalite bleaches among those described above are the alkali metal or alkaline earth metal hypochlorites selected from the group consisting of sodium, potassium, magnesium, lithium and calcium hypochlorites, and mixtures thereof. Sodium hypochlorite is the most preferred hypohalite bleach.

Suitable peroxygen bleaches to be used herein include hydrogen peroxide (or water soluble sources thereof), persulfates (such as monopersulfates), persilicates, peroxyacids, alkyl peroxides and acyl peroxides. A hydrogen peroxide source refers to any compound that produces hydrogen peroxide when said compound is in contact with water, such as for instance percarbonates and perborates. Preferred peroxygen bleaches are organic peroxyacids, such as for instance peroxyacetic acid, peroxyoctanoic acid, peroxynonanoic acid and diperoxydodecandioic acid. A particularly preferred peroxyacid is 6-(phthalimidoperoxy)-hexanoic acid (PAP).

The bleach is preferably delivered in the form of an additive. Further ingredients of the bleach additive can include chelants, viscosity regulators, buffers, physical or chemical stabilizers, perfume and fabric care agents.

Preferably, the level of bleach in the wash/rinse liquor is from about 50 to about 1500 ppm, from about 50 to about 500 ppm or from about 50 to about 300 ppm.

### Examples

Example 1 shows how the soil release polymer prevents patchy damage caused by the hueing dye at high concentrations while it does not affect hueing dye deposition at in use levels. Example 1 also shows how the whitening composition of the invention provides improved whitening, and whitening rejuvenation.

Example 2 shows that better whitening is achieved using a program with only one rinse and the whitening additive of the invention than using three rinses. It also shows that the whitening additive of the invention provides multicycle grease stain removal on cotton.

### Test Methods

Fabric swatches used in the test methods herein were obtained from Warwick Equest—20 cm×20 cm Whiteness Tracer bundles containing (EQKC1 Knitted Cotton swatch, EQPC1 Polycotton swatch and EQPE1 Polyester swatch).

All whiteness and cleaning tests were carried out in a programmable 7 kg Electrolux W565H wash extractors with a wash cycle consisting of 2 main washes and either 3 rinses or 1 rinse.

All the whiteness experiments were conducted up to 4 cycles. After each cycle was finished, the ballast load and the whiteness tracers were removed from the washing machine and introduced in an Electrolux T5250 gas dryer where they were dried for 30 minutes at low temperature.

All reflectance spectra and color measurements, including L*, a*, b*, and Whiteness Index (WI CIE) values on dry fabric swatches, were made using a Konica-Minolta 3610d reflectance spectrophotometer (Konica Minolta Sensing Europe B.V., U.K. Branch, Unit 9, Webster Court, Westbrook Crescent, Gemini Business Park, Warrington, WAS 8WD; D65 illumination, 10° observer, UV light adjusted and Specular Component Excluded). Afterwards, the delta WI CIE was calculated as the difference in the whiteness index before and after wash for each of the whiteness swatches (ΔWI CIE=WI CIE_{after}−WI CIE_{before}). The results presented correspond to the average of the 2 internal replicates for each experimental condition after 4 washing cycles.

### Materials Used:

Tide SC— typical laundry surfactant-based detergent containing enzymes. Supplied by Procter & Gamble. Concentration in the wash of detergent as is.

Dye—Liquitint® V200. Supplied by Milliken (Spartanburg, S.C., USA)—concentration in mg active per L
SRN—soil release polymer SRN 240. Supplied by Clariant—concentration in mg active per L
Br49—Optical brightener 49—concentration in mg active per L

### Example 1

Prevention of high concentration patchy damage from hueing dyes whilst still depositing at normal dosage to provide a whiteness benefit

### Test Conditions

All testing was carried out in the absence of soil in order to focus solely on the deposition of hueing dye and brightener without interference of soil deposition.

### Procedure 10 Times Concentration Exposure to the Additive

Polyester and cotton tracers were added in 2 L beakers containing test products and 1 L deionized water at room temperature for 2 mins, under agitation. The fabrics were squeezed by hand, the beaker was drained and refilled with 1 L of deionized water, and left under agitation for a further 2 min. The fabrics were squeezed by hand and dried in a gas dryer with a towel for 10 mins.

### Case A

The beaker contained 0.4 ppm of hueing dye, representative of a 10 times dye concentration vs a typical addition in the wash. This high concentration represents what could happen when a concentrated additive is added to a very full washing machine and takes time to fully disperse through the load and the fabric is exposed to localized high concentration.

Both cotton and polyester tracers were intensely blue/purple and would not be recognized or accepted as a white fabric.

### Case B

Case A was repeated but with the addition of the soil release polymer. The beaker contained 0.4 ppm of hueing dye and 470 ppm of SRN240, representative of a 10 times concentration of a composition under the scope of this invention. This time, both cotton and polyester tracers appear perfectly white with no visible trace of any dye.

This indicates the ability of the polymer to prevent heavy and visible deposition of the hueing dye, thus preventing patchy damage in cases of localized high concentrations. In turn, this benefit allows for the formulation of a very concentrated product without concerns about patchy damage.

Having established the anti-deposition properties of the polymer with regards to the dye, one might expect that at low wash concentration, no dye is being deposited either. Surprisingly, we have found that at low concentrations, the polymer does not interfere with dye deposition and the whiteness performance is the same whether the polymer is present or not.

### Wash Concentration Performance

Using programmable 7 kg Electrolux W565H wash extractors with a wash cycle consisting of 2 main washes at 32° C. followed by a single rinse. Technical tracers (Warwick Equest—EQKC1 Knitted Cotton swatch, EQPC1 Polycotton swatch and EQPE1 Polyester swatch) were repeatedly washed 4 times with a 5 kg mixed cotton and polycotton ballast in 8p hardness water.

| Test Legs | Main wash 1 | Main Wash 2 | Rinse |
|---|---|---|---|
| Dye | 885 ppm Tide SC | 107 ppm sodium | 0.04 ppm dye |
| | | Hypochlorite | |
| SRN + dye | 885 ppm Tide SC | 107 ppm sodium | 47 ppm SRN + |
| | | Hypochlorite | 0.04 ppm dye |
| SRN + dye + | 885 ppm Tide SC | 107 ppm sodium | 47 ppm SRN + |
| Br49 | | Hypochlorite | 0.04 ppm dye + |
| | | | 3 ppm Br49 |

The delta values vs WI CIE prior to washing are all positive

With new, white tracers, the same whiteness performance was observed whether the polymer was present or not (a ΔWI CIE of less than 2 is considered not distinguishable by eye). This indicates that even though the polymer prevented over-hueing at high concentration, it did not impact dye deposition at wash concentrations. In clean systems both hueing dye and brightener maintain the starting whiteness.

| New items | | | |
|---|---|---|---|
| Delta WI CIE after 4 cycles vs | | | |
| unwashed | Knitted cotton | Polycotton | Polyester |
| Dye | −0.67 | 0.70 | 1.31 |
| SRN + dye | −0.71 | 1.22 | 1.42 |
| SRN + dye + Br49 | −0.55 | 2.48 | 1.46 |

We also used artificially aged tracers which have previously been yellowed/damaged through repeated washing with hypochlorite bleach. These yellowed tracers are useful to test the ability of the test dye to rejuvenate the appearance of these items back to white.

The delta value vs WI CIE prior to washing were all positive. A further benefit of adding the combination of the hueing dye and soil release polymer is that the whitening effect across multiple fabrics is leveled versus using hueing dye alone. The WI CIE between the least improved and most improved fabrics for hueing alone was 2.01, whereas the difference using the combination is only 1.42. The combination provides a more even whitening effect across the range of fabrics.

| Rejuvenation of yellow items | | | |
|---|---|---|---|
| Delta WI CIE after 4 cycles | Knitted cotton | Polycotton | Polyester |
| Dye | 6.44 | 3.51 | 3.43 |
| SRN + Dye | 5.12 | 3.70 | 4.15 |
| SRN + Dye + Br49 | 11.06 | 6.32 | 3.41 |

Example 2 Managing residual soil and preventing redeposition when rinse numbers are cut from 3 to 1

### Test Design

The washing step comprised two main washes at 50° C. 10×SBL2004 soil sheets (WFK Testgewebe GmbH, Germany) were added at the start of the first main wash.

The detergent was added in the first main wash and hypochlorite bleach was added in the second main wash. The rinsing step in the reference cycle comprises 3 rinses and only 1 rinse for the method of invention. Whiteness maintenance after one and 4 cycles are reported below.

| Cycle | Main wash 1 | Main Wash 2 | final Rinse |
|---|---|---|---|
| 3 Rinses | 885 ppm Tide | 107 ppm sodium | NA |
| | SC | Hypochlorite | |
| 1 Rinse | 885 ppm Tide | 107 ppm sodium | 47 ppm SRN + 0.04 |
| | SC | Hypochlorite | ppm Dye |
| 1 Rinse | 885 ppm Tide | 107 ppm sodium | 47 ppm SRN + 0.04 |
| | SC | Hypochlorite | ppm Dye + 3 ppm Br49 |

### Results

Fabrics containing synthetic hydrophobic fibres are the most prone to soil redeposition: polyester is worse on whiteness than polycotton which is worse than cotton (more negative delta WI CIE vs unwashed).

Despite the reduction in the number of rinses, the polymer and dye combination provide the best whiteness in presence of high soil for those fabrics that are most affected (polycotton and polyester).

| | Knitted cotton | Polycotton | Polyester |
|---|---|---|---|
| New items | | | |
| Delta WI CIE after 1 cycle | | | |
| 3 Rinses Nil additive | −4.3 | −6.9 | −19.4 |
| 1 Rinse with SRN + Dye | −3.4 | −6.3 | −16.2 |
| 1 Rinse with SRN + Dye + | −3.4 | −5.4 | −13.3 |
| Br49 | | | |
| New items | | | |
| Delta WI CIE after 4 cycles | | | |
| 3 Rinses Nil additive | −8.0 | −18.1 | −32.3 |
| 1 Rinse with SRN + Dye | −7.5 | −14.5 | −6.1 |
| 1 Rinse with SRN + Dye + | −8.2 | −14.0 | −6.2 |
| Br49 | | | |

### Stain Removal Measurement:

Stains obtained via Warwick Equest on a CW120 Cotton background fabric (30 cm×20 cm) apart from Sebum which is on a Polycotton background fabric.

The extent of stain removal performance achieved by any wash cycle is calculated as the colour difference between the stain and the textile's background before and after wash. The initial colour difference is defined as initial noticeability (IN, Equation 1), whereas the final noticeability Equation 2) refers to the colour difference between the stains after the wash and the textiles initial background. The Stain Removal Index (SRIᵢ) for a given stain i is calculated as a described by Equation 3.

$$I {N}_{i} = \sqrt{{( {L}_{{s}_{io}} - {L}_{{b}_{o}} )}^{2} + {( {a}_{{s}_{io}} - {a}_{{b}_{o}} )}^{2} + {( {b}_{{si}_{o}} - {b}_{{b}_{o}} )}^{2}} \qquad Equation 1$$

$$F {N}_{i} = \sqrt{{( {L}_{{s}_{if}} - {L}_{{b}_{o}} )}^{2} + {( {a}_{{s}_{if}} - {a}_{{b}_{o}} )}^{2} + {( {b}_{{s}_{if}} - {b}_{{b}_{o}} )}^{2}} \qquad Equation 2$$

$${SRI}_{i} ( \% ) = \frac{I {N}_{i} - F {N}_{i}}{I {N}_{i}} \cdot 100 \qquad Equation 3$$

Stain removal on cotton is better with a wash having only one rinse cycle than with a wash having three rinse cycles, when the whitening additive of the invention is added to the one rinse cycle. There is an un-expected improvement on greasy stain removal on cotton fabrics.

The polymer performance is well known to happen on synthetic fabrics via a soil release effect (when the fabrics have been pre-treated with the polymer) but the same mechanism does not work on hydrophilic fabrics such as cotton. Stained cotton swatches which have had no prior exposure to the polymer (so called untreated cotton) show a stain removal improvement across many greasy stains.

| | 3 Rinse | 1 Rinse cycle | 1 Rinse cycle |
|---|---|---|---|
| SRI for reference | reference | with SRN + | with SRN + |
| Delta vs reference | cycle | V200 | V200 + Bri49 |
| Dyed Lard (DBG001) | 82.6 | +4.5 | +4.1 |
| Burnt Butter (BB001) | 71.9 | +2.6 | +4.3 |
| Cooked Beef Fat (CBE001) | 70.1 | +3.3 | +6.6 |
| Dyed Bacon Grease | 83.8 | +4.7 | +5.5 |
| (DBG001) | | | |
| Sebum (PCS-132) | 29.0 | +3.0 | +3.1 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of laundering fabrics, comprising the step of delivering a detergent and a whitening additive wherein the whitening additive comprises:
(a) a soil release polymer;
(b) a hueing dye; and
wherein if the whitening additive comprises a surfactant, the weight ratio of the polymer to the surfactant is at least 1:1.

2. A process according to claim 1 wherein weight ratio of the polymer to the surfactant is at least 2:1.

3. A process according to claim 1 wherein the whitening additive is substantially free of surfactant.

4. A process according to claim 1 wherein the process takes place in a professional laundry machine.

5. A process according to claim 1 wherein the process comprises one or more washing steps and one or more rinse steps wherein if one of the rinse steps contains whitening additive and there is one or more subsequent rinse step, each rinse step substantially free of the whitening additive uses less water than the rinse step containing the whitening additive.

6. A process according to claim 1 wherein the process comprises one or more washing steps and a single rinse step.

7. A process according to claim 1 wherein the whitening additive is delivered in a rinse step.

8. A process according to claim 1 wherein the process comprises one or more washing steps and more than one rinse steps and wherein the whitening additive is delivered in the last rinse step.

9. A process according to claim 1 wherein the soil release polymer has a structure according to the formula below: 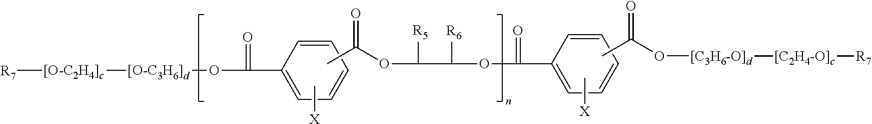
wherein:
each R₅ and R₆ is independently selected from H or CH₃;
c, d are, based on molar average, a number independently selected from 0 to 200, and wherein the sum of c+d is from 2 to 400;
R₇ is selected from H, C₁₋₄ alkyl, —CH₂—CH₂—SO₃⁻(Mⁱ⁺)_{y}, or 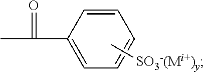
and
n is, based on molar average, from 1 to 50;
each X is independently selected from H or SO₃⁻(Mⁱ⁺)_{y};
wherein, M is H or a mono- or divalent cation;
i is 1 or 2;
y is 1/i.

10. A process according to claim 1 wherein the soil release polymer has a structure according to the formula below: 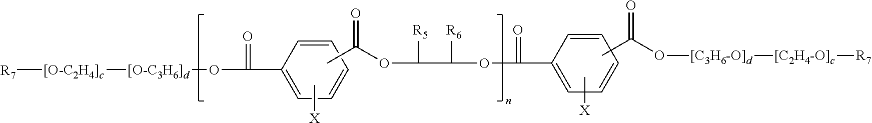
wherein:
each R₅ and R₆ is independently selected from H or CH₃;
c, d are, based on molar average, a number independently selected from 0 to 200, and wherein the sum of c+d is from 2 to 400;
R₇ is selected from H, C₁₋₄ alkyl, —CH₂—CH₂—SO₃⁻(Mⁱ⁺)_{y}, or 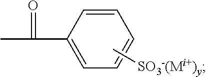
and
n is, based on molar average, from 1 to 10;
each X is independently selected from H or SO₃⁻(Mⁱ⁺)_{y};
wherein, M is H or a mono- or divalent cation;
i is 1 or 2;
y is 1/i.

11. A process according to claim 1, wherein the soil release polymer is a nonionic terephthalate-derived soil release polymer having a structure according to the formula below: 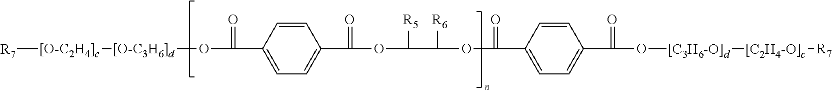
wherein:
each R₅ and R₆ is independently selected from H or CH₃;
c, d are, based on molar average, a number independently selected from 0 to 200, and wherein the sum of c+d is from 2 to 400;
R₇ is C₁-4 alkyl; and
n is, based on molar average, from 1 to 50.

12. A process according to claim 1, wherein the soil release polymer is a nonionic terephthalate-derived soil release polymer having a structure according to the formula below: 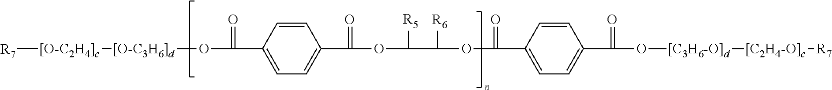
wherein:
each R₅ and R₆ is independently selected from H or CH₃;
c, d are, based on molar average, a number independently selected from 0 to 200, and wherein d is 0 to 10 and c is 5 to 150;
R₇ is methyl; and
n is, based on molar average, from 1 to 10.

13. A process according to claim 1 wherein the hueing dye is selected from the group consisting of small molecule dyes, polymeric dyes, and mixtures thereof.

14. A process according to claim 1 wherein the whitening additive further comprises a brightener.

15. A process according to claim 1 wherein the whitening additive is substantially free of perfume.

16. A process according to claim 1 wherein the process comprises the further step of delivering peroxyacid bleach, and wherein the bleach is delivered before the whitening additive.

17. A concentrated whitening additive composition suitable for use in the process according to claim 1, the additive comprising:
(a) at least 10% by weight of the composition of soil release polymer; and
(b) at least 0.001% by weight of the composition of hueing dye; and
(c) a brightener.
and wherein if the whitening additive comprises a surfactant, the weight ratio of the polymer to the surfactant is at least 1:1.

18. A concentrated whitening additive composition suitable for use in the process according to claim 1, the additive comprising:
(a) at least 10% by weight of the composition of soil release polymer; and
(b) at least 0.001% by weight of the composition of hueing dye; and
(c) a brightener
and wherein if the whitening additive comprises a surfactant, the weight ratio of the polymer to the surfactant is at least 2:1

19. A concentrated whitening additive composition suitable for use in the process according to claim 1, the additive comprising:
(a) at least 10% by weight of the composition of soil release polymer; and
(b) at least 0.001% by weight of the composition of hueing dye; and wherein if the whitening additive comprises a surfactant, the weight ratio of the polymer to the surfactant is at least 1:1
and wherein the soil release polymer has a structure according to the formula below: 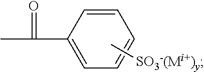
wherein:
each R₅ and R₆ is independently selected from H or CH₃;
c, d are, based on molar average, a number independently selected from 0 to 200, and wherein the sum of c+d is from 2 to 400;
R₇ is selected from H C₁₋₄ alkyl, —CH₂—CH₂— SO₃⁻(Mⁱ⁺)_{y}, or 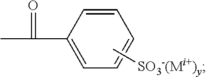
and
n is, based on molar average, from 1 to 50;
each X is independently selected from H or SO₃⁻(Mⁱ⁺)_{y};
wherein, M is H or a mono- or divalent cation;
i is 1 or 2;
y is 1/i.

20. A concentrated whitening additive composition suitable for use in the process according to claim 1, the additive comprising:
(a) at least 10% by weight of the composition of soil release polymer; and
(b) at least 0.001% by weight of the composition of hueing dye; and wherein if the whitening additive comprises a surfactant, the weight ratio of the polymer to the surfactant is at least 1:1
and wherein the soil release polymer is a nonionic terephthalate-derived soil release polymer having a structure according to the formula below: 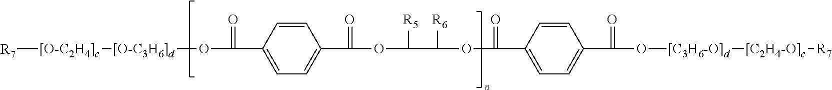
wherein:
each R₅ and R₆ is independently selected from H or CH₃;
c, d are, based on molar average, a number independently selected from 0 to 200, and wherein the sum of c+d is from 2 to 400;
R₇ is C₁₋₄ alkyl; and
n is, based on molar average, from 1 to 50.
